(19) United States
(12) Patent Application Publication
(10) Pub. No.: US 2005/0229153 A1
(43) Pub. Date: Oct. 13, 2005

(54) Method, apparatus, and program for application design based on diagram specialization

(75) Inventors: Guruduth Somasekhara Banavar, Yorktown Heights, NY (US); Richard J. Cardone, Mahopac, NY (US); Shin-ichi Hirose, Tokyo (JP); Gary Martin Johnston, Chapel Hill, NC (US); Danny Soroker, Larchmont, NY (US); Timothy Wilson, Chapel Hill, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/819,784

(22) Filed: Apr. 7, 2004

(51) Int. Cl. G06F 9/44

(52) U.S. Cl. 717/106; 717/109; 717/113; 717/104; 717/105; 717/107; 717/120

(57) ABSTRACT

A diagramming tool is provided that allows a diagram to be defined as a specialization of a “parent” diagram. The “child” diagram is defined based on the “parent” diagram such that the child diagram references the parent and contains only nodes and edges which represent differences between the instant diagram and its parent diagram. A diagram inherits all of the nodes and edges, and their properties, of its parent and adds, deletes, or redefines the nodes and/or edges that represent the differences or specializations.

### BACKGROUND OF THE INVENTION

1. Technical Field

The present invention relates to data processing and, in particular, to diagramming and application design. Still more particularly, the present invention provides a method, apparatus, and program for application design based on diagram specialization.

2. Description of Related Art

Diagrams may be used to represent organizational layouts, data flow, and other relationships. A typical diagram, or graph, consists of nodes and interconnecting lines, referred to as “edges.” For example, it is often very useful to diagram the design or implementation of a software application in terms of nodes and edges, each with arbitrary properties, that represent the control flow of the software application components. As a more specific example, a diagram of a Java 2 Platform, Enterprise Edition (J2EE) based Web application might consist of nodes, which represent the JavaServer Pages (JSP) and top-level business logic, and edges, which represent the top-level application control flow. Some vendors offer software development tools that support this kind of application diagramming. The Web Diagram Editor in International Business Machine's WebSphere Studio v5.0 (and later) is one such tool.

In some cases, one needs to design or develop multiple variations of an application for various different execution contexts. For example, if one were to design a Web application that targets various models of Web-capable cell phones and/or personal digital assistants, one might need a somewhat different variant of the application for each device type (or category of device type) due to screen size differences or other device differences. As another example, if one were to design a Web-based online banking application that is to serve users in multiple political/governmental jurisdictions (locales) with different banking regulations, a different variant of the application may be needed for each locale. For each variant of a software application, the diagram may have somewhat different sets of nodes and edges. Each of these kinds of contexts for which one might want to develop a set of application variants can be though of as a “dimension of variability”. The variants are typically very similar. In other words, most of the nodes and edges may be the same in all of the variants with only a relatively small subset of the nodes and/or edges being different in any particular variant.

Currently available diagramming tools are inadequate for this kind of situation. For example, when using a diagramming tool to design a software application with variants, a developer may create and maintain a single diagram to represent the union of all the application variants. This may result in a large, unwieldy diagram that is cluttered with the details of the differences between the underlying variants, obfuscating the overall, largely common application flow. Typically, a designer may want to subdivide such an overly large diagram into multiple, non-overlapping (i.e., disjoint) diagrams. However, this means sacrificing the ability to see all of the detail of the underlying common application flow in a single diagram. Also, the “dimension of variability” is lost or is at least very hard to see and is spread across the multiple diagrams. With multiple levels of variability, for example, arbitrarily deep subcategories of devices or sub-locales, the situation becomes even more difficult.

Alternatively, when using a diagramming tool to design a software application with variants, a developer may create and maintain multiple diagrams, one for each application variant. Of course, this means that the nodes and edges that are common to the multiple application variants are duplicated in each variant. This makes it difficult and error prone when changes are made to the application, because the designer must make the same change to every diagram when a common component is modified. When multiple levels of variability is desired, the number of diagrams may escalate to an unmanageable level.

### SUMMARY OF THE INVENTION

The present invention recognizes the disadvantages of the prior art and provides a diagramming tool that allows a diagram to be defined, specified, and stored as a specialization of a “parent” diagram. The “child” diagram is defined based on the “parent” diagram such that the child diagram references the parent and contains only nodes and edges which represent differences between the instant diagram and its parent diagram. Conceptually and semantically, a diagram inherits all of the nodes and edges, and their properties, of its parent and adds, deletes, or redefines the nodes and/or edges that represent the differences or specializations.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIGS. 3A and 3B are block diagrams depicting a diagramming tool in accordance with exemplary embodiments of the present invention;

FIGS. 4A and 4B illustrate an example diagram in accordance with a preferred embodiment of the present invention;

FIGS. 5A-5C illustrate an example diagram specialization in accordance with a preferred embodiment of the present invention;

FIGS. 6A and 6B illustrate a diagramming tool interface for illustrating specializations in accordance with an exemplary embodiment of the present invention; and

FIGS. 7A and 7B are flowcharts illustrating the operation of a diagramming tool in accordance with a preferred embodiment of the present invention.

### DETAILED DESCRIPTION OF THE PREFERRED EMBODIMENT

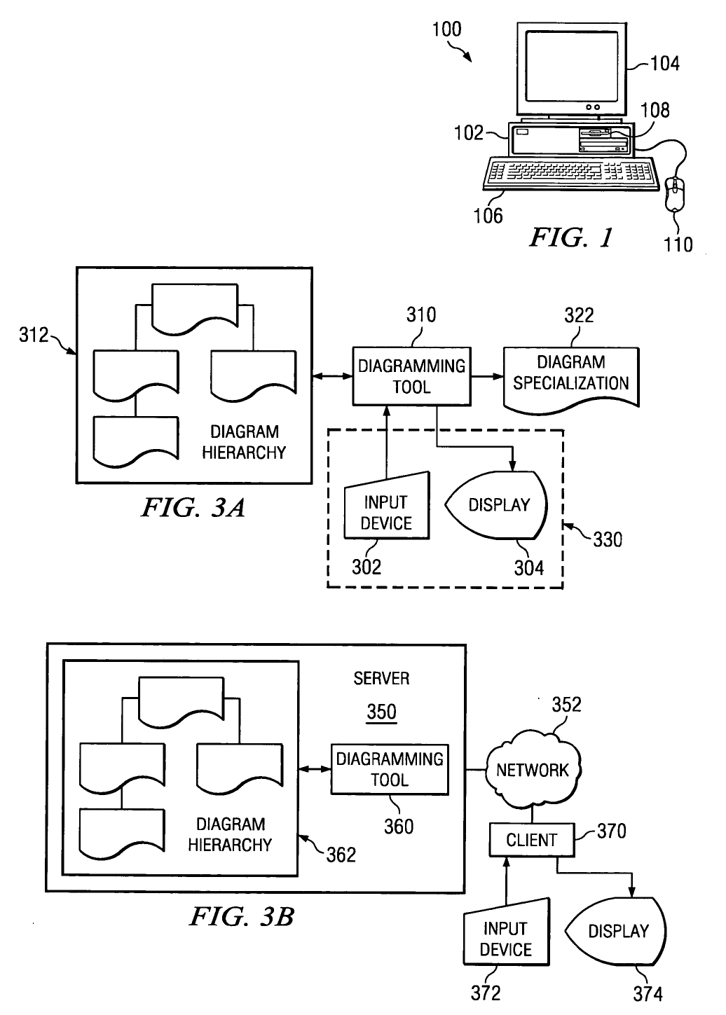

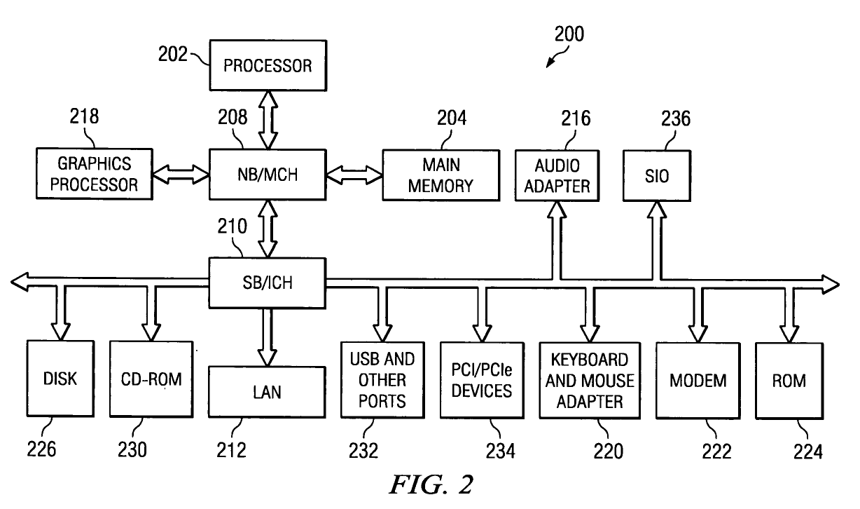

The present invention provides a method, apparatus and computer program product for application design based on diagram specialization. The data processing device may be a stand-alone computing device or may be a distributed data processing system in which multiple computing devices are utilized to perform various aspects of the present invention. Therefore, the following FIGS. 1 and 2 are provided as exemplary diagrams of data processing environments in which the present invention may be implemented. It should be appreciated that FIGS. 1 and 2 are only exemplary and are not intended to assert or imply any limitation with regard to the environments in which the present invention may be implemented. Many modifications to the depicted environments may be made without departing from the spirit and scope of the present invention.

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like.

Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. In the depicted example, data processing system 200 employs a hub architecture including a north bridge and memory controller hub (MCH) 208 and a south bridge and input/output (I/O) controller hub (ICH) 210. Processor 202, main memory 204, and graphics processor 218 are connected to MCH 208. Graphics processor 218 may be connected to the MCH through an accelerated graphics port (AGP), for example.

In the depicted example, local area network (LAN) adapter 212, audio adapter 216, keyboard and mouse adapter 220, modem 222, read only memory (ROM) 224, hard disk drive (HDD) 226, CD-ROM driver 230, universal serial bus (USB) ports and other communications ports 232, and PCI/PCIe devices 234 may be connected to ICH 210. PCI/PCIe devices may include, for example, Ethernet adapters, add-in cards, PC cards for notebook computers, etc. PCI uses a cardbus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to ICH 210.

An operating system runs on processor 202 and is used to coordinate and provide control of various components within data processing system 200 in FIG. 2. The operating system may be a commercially available operating system such as WINDOWS XP, which is available from Microsoft Corporation, or an open-source operating system such as Linux. An object oriented programming system such as Java may run in conjunction with the operating system and provides calls to the operating system from Java programs or applications executing on data processing system 200. “JAVA” is a trademark of Sun Microsystems, Inc. Instructions for the operating system, the object-oriented programming system, and applications or programs are located on storage devices, such as hard disk drive 226, and may be loaded into main memory 204 for execution by processor 202. The processes of the present invention are performed by processor 202 using computer implemented instructions, which may be located in a memory such as, for example, main memory 204, memory 224, or in one or more peripheral devices 226 and 230.

Those of ordinary skill in the art will appreciate that the hardware in FIG. 2 may vary depending on the implementation. Other internal hardware or peripheral devices, such as flash memory, equivalent non-volatile memory, or optical disk drives and the like, may be used in addition to or in place of the hardware depicted in FIG. 2. Also, the processes of the present invention may be applied to a multiprocessor or distributed data processing system.

For example, data processing system 200 may be a personal digital assistant (PDA), which is configured with flash memory to provide non-volatile memory for storing operating system files and/or user-generated data. The depicted example in FIG. 2 and above-described examples are not meant to imply architectural limitations. For example, data processing system 200 also may be a tablet computer, laptop computer, or telephone device in addition to taking the form of a PDA.

As mentioned above, the present invention provides a diagramming tool that allows a diagram to be defined, represented, or specified as a specialization of a “parent” diagram. The “child” diagram is defined based on the “parent” diagram such that the child diagram references the parent and specifies only nodes and edges which represent differences between the instant diagram and its parent diagram. A diagram inherits all of the nodes and edges, and their properties, of its parent and adds, deletes, or redefines the nodes and/or edges that represent the differences or specializations. Note that a parent diagram may itself be the child of another diagram. Also, a child diagram may itself be the parent of one or more other diagrams. Therefore, the diagram inheritance structure forms a hierarchy, or tree structure, of arbitrary depth, size and complexity.

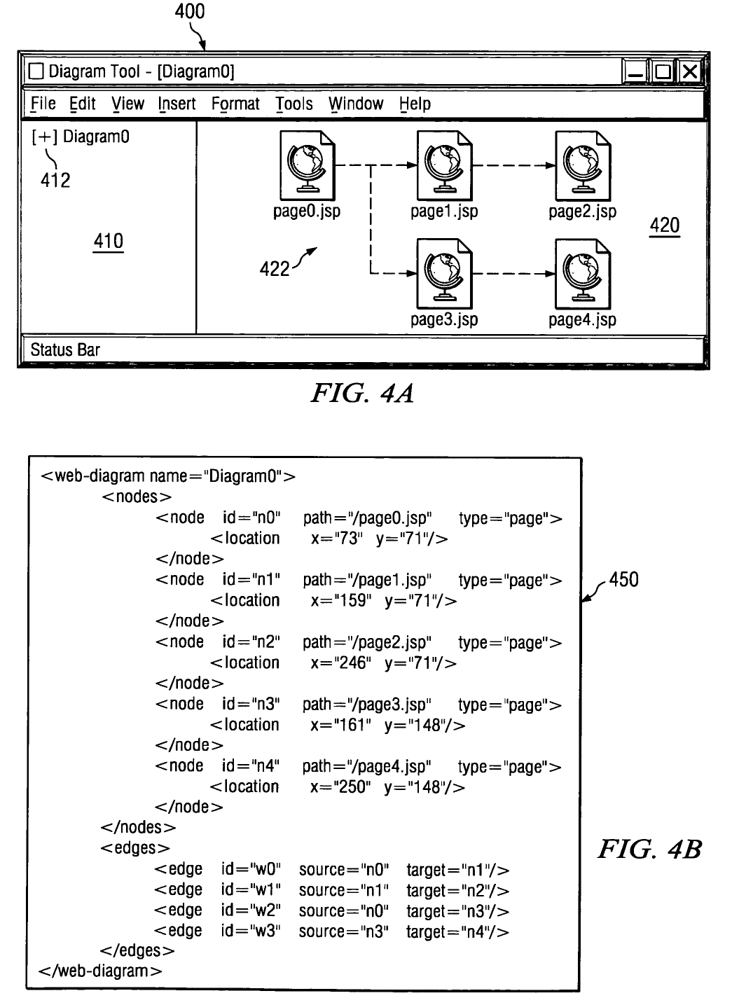

FIGS. 3A and 3B are block diagrams depicting a diagramming tool in accordance with exemplary embodiments of the present invention. More particularly, with reference to FIG. 3A, diagramming tool 310 allows a user to define a diagram as a specialization of a parent diagram. Diagram hierarchy 312 is thus created, wherein a given diagram may refer to a parent diagram and contain only nodes and edges which represent differences between the instant diagram and its parent diagram.

A user may view a parent diagram, for example one of the diagrams in diagram hierarchy 312, and view the diagram using display 304. The user may then create specializations by adding, deleting, or redefining nodes and/or edges using input device 302. Diagram specialization 322 may then be generated as a reference to a parent diagram and definitions of those nodes that are added, deleted, or redefined in the specialization. Diagram specialization 322 may then be stored in diagram hierarchy 312. Diagram specialization 322 inherits all of the nodes and edges, and their properties, of its parent and adds, deletes, or redefines the nodes and/or edges that represent the differences or specializations.

Diagramming tool 310 also allows a user to navigate diagram hierarchy 312 using input device 302 and display 304. Common nodes and edges between a diagram specialization and those of its parent may be displayed in a first format while added nodes and edges are displayed in a second format, deleted nodes and edges are displayed in a third format, and redefined nodes and edges are displayed in a fourth format. In other words, the specializations may be highlighted in a diagram while the common or inherited nodes and edges are presented to illustrate the dimension of variability. The user may also easily navigate from one level of the diagram hierarchy to another to view multiple levels of variability.

Diagramming tool 310 may be software running on a computer, such as data processing system 200 in FIG. 2. Alternatively, diagramming tool 310 may be a server application running on a server, such as a Web server. Input device 302 and display 304 may be embodied in a client device 330 running client software that communicates with the server. For example, client device 330 may be running a Web browser that provides an interface for diagramming tool 310. The Web browser may communicate with a Web server to perform operations by means of diagramming tool 310.

Turning to FIG. 3B, a diagramming tool in a client/server architecture is shown in accordance with an exemplary embodiment of the present invention. Server 350 communicates with client 370 through network 352, which is the medium used to provide communications links between various devices and computers connected together. Network 352 may include connections, such as wire, wireless communication links, or fiber optic cables.

Clients 370 may be, for example, a personal computer or network computer. In the depicted example, server 350 provides diagramming tool application 360 to client 370. Clients 370 is a client to server 350. The client server architecture may include additional servers, clients, and other devices not shown.

In the depicted example, the client server architecture may be the Internet with network 352 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, the client/server architecture also may be implemented as a number of different types of networks, such as for example, an intranet, a local area network (LAN), or a wide area network (WAN). FIG. 3B is intended as an example, and not as an architectural limitation for the present invention.

Diagramming tool 360 allows a user to define a diagram as a specialization of a parent diagram. Diagram hierarchy 362 is thus created, wherein a given diagram may refer to a parent diagram and contain only nodes and edges which represent differences between the instant diagram and its parent diagram. A user may view a parent diagram, for example one of the diagrams in diagram hierarchy 362, and view the diagram using display 374. The user may then create specializations by adding, deleting, or redefining nodes and/or edges using input device 372. Diagramming tool 360 also allows a user to navigate diagram hierarchy 362 using input device 372 and display 374.

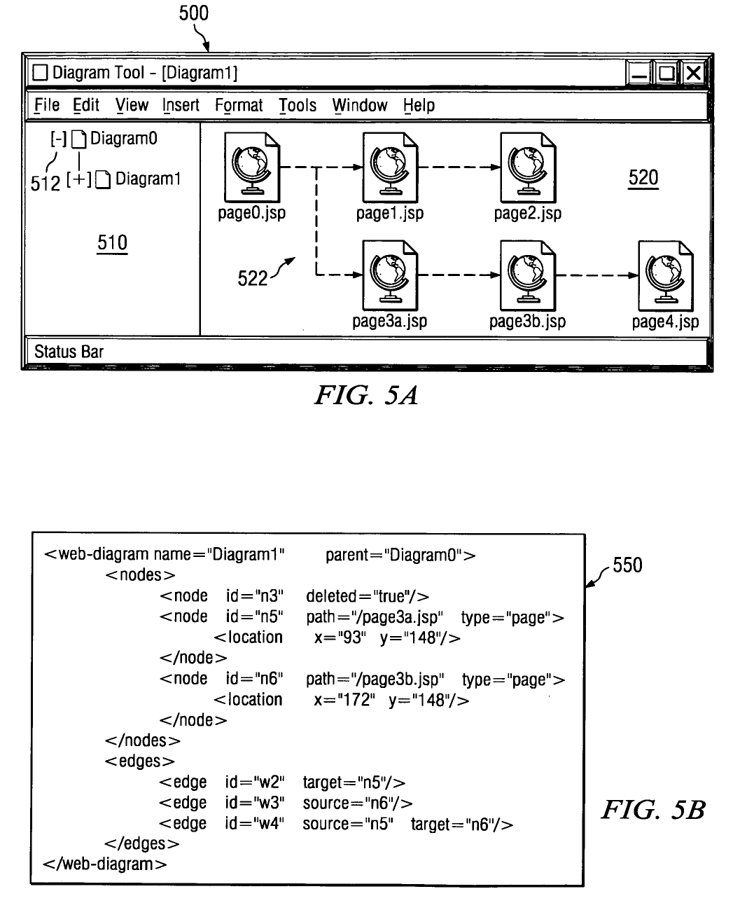

FIGS. 4A and 4B illustrate an example diagram in accordance with a preferred embodiment of the present invention. With reference to FIG. 4A, an example diagramming tool screen of display is illustrated. The screen comprises window 400, which includes navigation area 410 and diagram display area 420. Navigation area 410 presents a diagram hierarchy from which a user may select a particular diagram or specialization. The diagram hierarchy may be collapsed or expanded, for example, in a manner similar to directory structures in a file management application. For example, a user may select to expand the diagram hierarchy by selecting control 412. Diagram display (and editing) area 420 presents a diagram that is selected in navigation area 410, in this case Diagram0 422.

FIG. 4B illustrates a representation of a diagram in accordance with an exemplary embodiment of the present invention. The nodes in the example diagram may represent Web pages for an application and the directed lines (edges) represent the possible page transitions. In the depicted example, diagram representation 450 is in extensible Markup Language (XML); however, other data structures or storage formats may be used to represent a diagram within the scope of the present invention.

In the example shown in FIG. 4B, a diagram is identified by a name, in this case “Diagram0,” and contains definitions for nodes and edges. Each node has an “id” attribute, which uniquely identifies the node. Note that the nodes in this example happen to have ids of n0-n4, which correspond to page0.jsp to page4.jsp; however, the ids need not correspond in number to the file name. In fact, that is usually not the case. Each node has a “path” attribute, which specifies the location and name of the Web page to which it refers. Each node may represent an application element, such as a JAVA Server Page (JSP), for instance. In this example, all of the nodes happen to be of type “page”, representing a Web page or a JSP; however, other node types are also possible and will be readily apparent to a person of ordinary skill in the art.

Edges represent interconnection and application control flow and/or data flow between nodes. Each edge has an “id” attribute which uniquely identifies the edge. Each edge also has a “source” and “target” attribute, which specify the IDs of its source and target nodes, respectively.

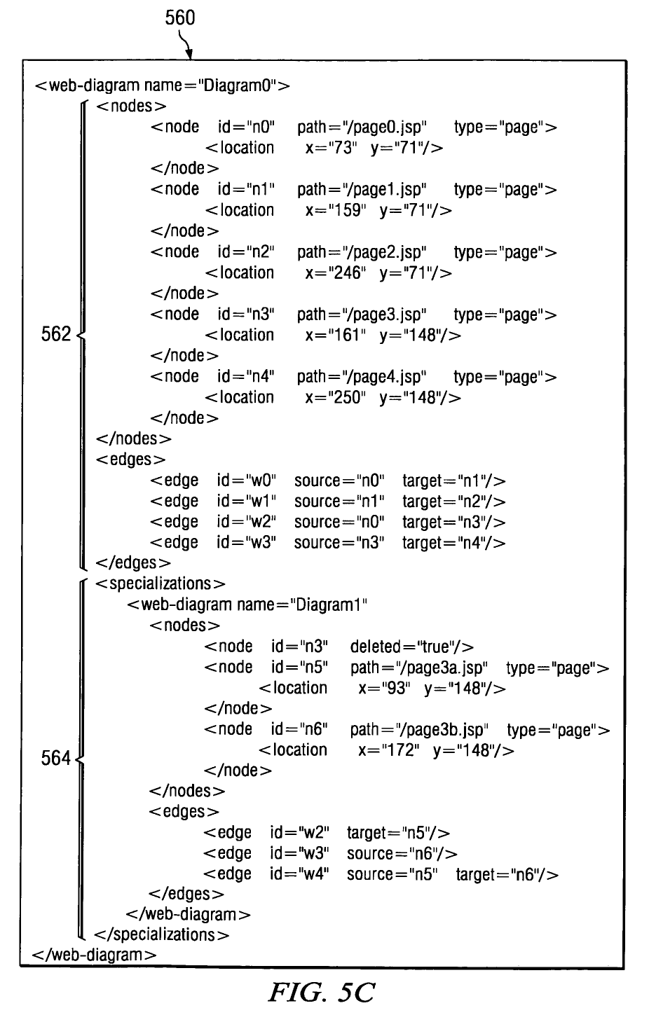

FIGS. 5A-5C illustrate an example diagram specialization in accordance with a preferred embodiment of the present invention. With reference to FIG. 5A, an example diagramming tool screen of display is illustrated. The screen comprises window 500, which includes navigation area 510 and diagram display area 520. Navigation area 510 presents a diagram hierarchy from which a user may select a particular diagram or specialization. The diagram hierarchy may be collapsed or expanded, for example, in a manner similar to directory structures in a file management application. For example, a user may select to collapse the diagram hierarchy by selecting control 512. As shown in the diagram hierarchy, Diagram1 is a child of Diagram0. That is, Diagram1 refers to Diagram0 as its parent and inherits the nodes and edges of its parent diagram Diagram0, as well as their properties.

Diagram display area 520 presents a diagram that is selected in navigation area 510, in this case Diagram1 522. In the illustrated example, Diagram1 is a specialization of Diagram0 shown in FIG. 4A. Diagram1 inherits the nodes and edges of Diagram0; however, node n3, “page3.jsp,” is replaced with two nodes, “page3a.jsp” and “page3b.jsp.”

FIG. 5B illustrates a representation of a diagram specialization in accordance with an exemplary embodiment of the present invention. In the depicted example, diagram representation 550 is in extensible Markup Language (XML); however, other data structures may be used to represent a diagram within the scope of the present invention. Note that, by default (i.e., by not mentioning them), Diagram1 inherits all of the nodes and edges, and their attribute values, of Diagram0. The node elements specified here for Diagram1 indicate the added, deleted, and/or redefined nodes and edges.

In the example shown in FIG. 5B, a diagram is identified by a name, in this case “Diagram1.” In this example, diagram representation 550 refers to a parent diagram, in this case “Diagram0,” and contains added nodes and/or edges, deleted nodes and/or edges, and redefined nodes and/or edges. As an example, node n3 is deleted form the parent node, as indicated by an attribute (deleted=“true”). Each added node in the depicted example is defined by an ID, a path for an application element, a type, and a location. Edge w2 is redefined to have a new target and edge w3 is redefined to have a new source. Edge w4 is added and is defined by an identification, a source node, and a target node.

In the example shown in FIG. 5B, a diagram specialization is defined by a reference to a parent and definitions of added, deleted, and redefined nodes and/or edges. Alternatively a diagram specialization may be specified by including the specification of Diagram1 within a <specializations>sub-element of diagram 0. FIG. 5C illustrates a representation of a diagram specialization that is specified as a sub-element of its parent diagram. Diagram representation 560 includes definitions 562 for nodes and edges for the parent diagram, Diagram0, and specializations 564 for the child diagram, Diagram1.

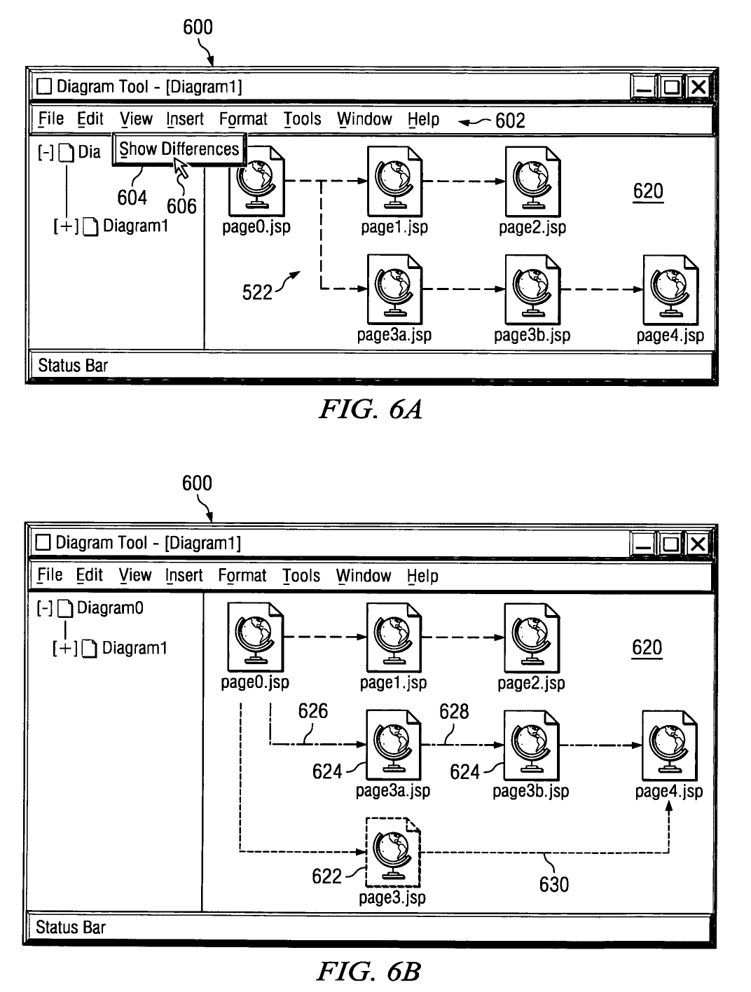

FIGS. 6A and 6B illustrate a diagramming tool interface for illustrating specializations in accordance with an exemplary embodiment of the present invention. More particularly, with reference to FIG. 6A, an example diagramming tool screen of display is illustrated. The screen comprises window 600, which includes diagram display area 620. As shown in this example, the diagram specialization presented in display area 620 does not highlight or differentiate the added, deleted, or modified nodes or edges.

Responsive to a user selection of the “View” menu in menu bar 602, a “View” menu drops down from the menu bar. The “View” menu may include, without limitation, a “Show Differences” option 604. A user may select the “View” menu in menu bar 602 and “Show Differences” option 604 using, for example, mouse pointer 606. Responsive to selection of a “Show Differences” option, the diagramming tool presents the diagram specialization with added, deleted, and redefined nodes and edges highlighted.

FIG. 6B illustrates an example diagramming tool screen of display with highlighted specializations. The screen comprises window 600, which includes diagram display area 620. As shown in the depicted example, the diagram specialization presented in display area 620 illustrates added nodes 624 in a particular format, such as highlighted borders. The deleted node, “page3.jsp” 622, is presented in a different format, such as a dotted border. Redefined nodes (not shown in this example) may also be presented in yet another format to distinguish form unmodified nodes.

Similarly, edges that are redefined, such as edge 626, are presented in a particular format, while edges that are added, such as edge 628, are presented in a different format. Edges that are deleted (not shown in this example) may be presented in yet another format. The diagramming tool may also present ghost edges, such as edge 630, to show previous interconnection to deleted nodes.

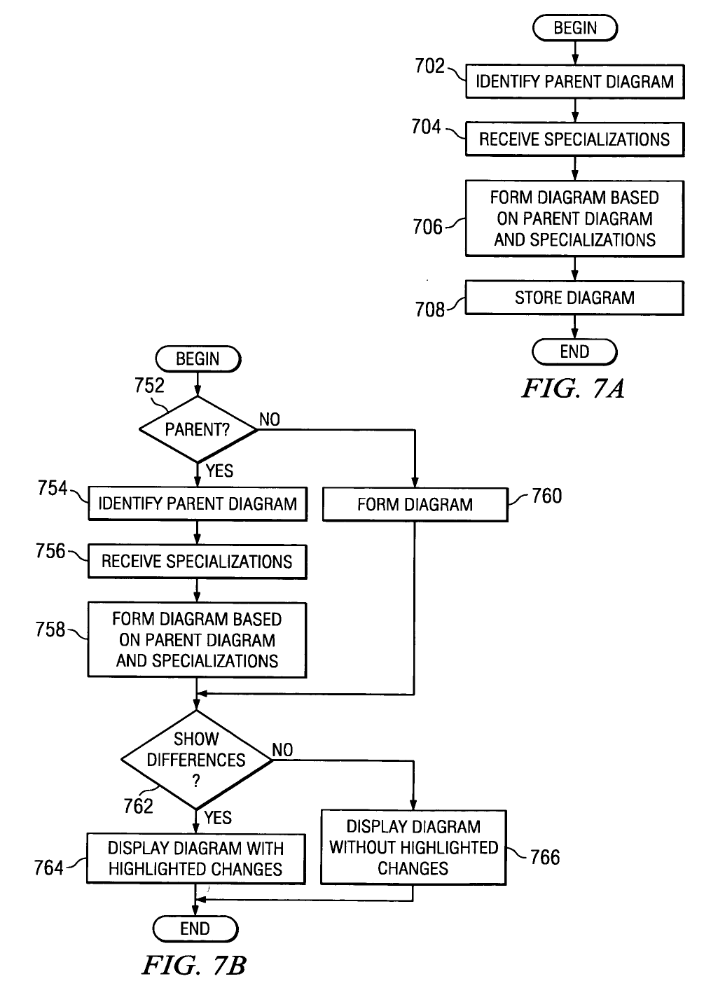

FIGS. 7A and 7B are flowcharts illustrating the operation of a diagramming tool in accordance with a preferred embodiment of the present invention. More particularly, with reference to FIG. 7A, a flowchart illustrating the operation of creating a diagram specialization is shown. The process begins and identifies a parent diagram (step 702). A parent diagram may be identified by receiving a selection from a user, for example. The process then receives specializations (step 704), which may include added nodes or edges, deleted nodes or edges, or redefined nodes or edges, for instance. Then, the process forms a diagram based on the parent diagram (which may itself have a parent diagram from which it must be formed) and the specializations (step 706). Thereafter, the process stores the diagram (step 708) and ends.

FIG. 7B is a flowchart illustrating the operation of displaying a diagram in accordance with a preferred embodiment of the present invention. The process begins and a determination is made as to whether the diagram refers to a parent diagram (step 752). If the diagram refers to a parent diagram, the process identifies the parent diagram (step 754) and receives specializations (step 756). The process then forms the diagram based on the parent diagram (which may itself have a parent diagram) and the specializations (step 758).

Returning to step 752, if the diagram does not refer to a parent diagram, i.e., the diagram does not have a parent, the process forms the diagram from the definitions in the diagram representation (step 760). After forming the diagram in step 758 or step 760, a determination is made as to whether the user wishes to show differences (step 762). If the user wishes to show differences, the process displays the diagram with highlighted differences (step 764) and ends. However, if the user does not wish to show differences in step 762, the process displays the diagram without highlighted differences (step 766) and ends.

Thus, the present invention solves the disadvantages of the prior art by providing a diagramming tool that allows a diagram to be defined as a specialization of a “parent” diagram. The “child” diagram is defined based on the “parent” diagram such that the child diagram references the parent and contains only nodes and edges which represent differences between the instant diagram and its parent diagram. A diagram inherits all of the nodes and edges, and their properties, of its parent and adds, deletes, or redefines the nodes and/or edges that represent the differences or specializations. The parent diagram may itself be the child of another diagram. Also, a child diagram may itself be the parent of one or more other diagrams. Therefore, the diagram inheritance structure forms a hierarchy, or tree structure, of arbitrary depth, size and complexity. The specializations may be highlighted in a diagram while the common (inherited) nodes and edges are presented in such ways as to illustrate or highlight the differences. The user may also easily navigate from one diagram in the diagram hierarchy to another diagram to view any specific diagram.

The technique for diagram specialization of the present invention may be applied more generally to any diagramming tool that deals with graphs, or, more generally, hypergraphs, even outside the domain of application design and development. Diagram specialization may also be applied more generally to diagrams that consist of diagram elements other than, or in addition to, nodes and edges. For example, diagram specialization may be applied to a JSP editor to support defining a specialization of a JSP based on another JSP.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for representing a specialization diagram based on specializations, the method comprising:
identifying a parent diagram, wherein the parent diagram defines at least one diagram element;
receiving at least one specialization modifying the parent diagram; and
forming a specialization diagram based on the parent diagram and the at least one specialization.

2. The method of claim 1, wherein the at least one diagram element includes a node having a set of properties and wherein the at least one specialization includes a node specialization.

3. The method of claim 2, wherein the node specialization adds a node to the parent diagram.

4. The method of claim 2, wherein the node specialization deletes a node from the parent diagram.

5. The method of claim 2, wherein the node specialization modifies a property within the set of properties for the node in the parent diagram.

6. The method of claim 1, wherein the at least one diagram element includes an edge that connects a source node to a target node and wherein the at least one specialization includes an edge specialization.

7. The method of claim 6, wherein the edge specialization adds an edge to the parent diagram.

8. The method of claim 6, wherein the edge specialization deletes an edge from the parent diagram.

9. The method of claim 6, wherein the edge specialization redefines one of the source node and the target node.

10. The method of claim 1, wherein forming the specialization diagram includes providing a markup language document including a reference to the parent diagram and the at least one specialization.

11. The method of claim 1, wherein forming the specialization diagram includes providing a markup language document including the at least one diagram element for the parent diagram and the at least one specialization.

12. The method of claim 1, further comprising:
storing the specialization diagram as a markup language document.

13. The method of claim 12, wherein the markup language document is an extensible markup language document.

14. The method of claim 1, wherein the parent diagram and the specialization diagram are part of a diagram hierarchy.

15. The method of claim 14, further comprising:
presenting a representation of the diagram hierarchy in a graphical user interface for navigation.

16. The method of claim 15, further comprising:
responsive to selection of a diagram in the diagram hierarchy, presenting the selected diagram in the graphical user interface.

17. The method of claim 1, further comprising:
presenting the specialization diagram.

18. The method of claim 17, wherein presenting the specialization diagram in the graphical user interface includes highlighting the at least one specialization with respect to the parent diagram.

19. An apparatus for representing a specialization diagram based on specializations, the method comprising:
means for identifying a parent diagram, wherein the parent diagram defines at least one diagram element;
means for receiving at least one specialization modifying the parent diagram; and
means for forming a specialization diagram based on the parent diagram and the at least one specialization.

20. A computer program product, in a computer readable medium, for representing a specialization diagram based on specializations, the computer program product comprising:
instructions for identifying a parent diagram, wherein the parent diagram defines at least one diagram element;
instructions for receiving at least one specialization modifying the parent diagram; and
instructions for forming a specialization diagram based on the parent diagram and the at least one specialization.

21. The computer program product of claim 20, wherein the at least one diagram element includes a node having a set of properties and wherein the at least one specialization includes a node specialization.

22. The computer program product of claim 20, wherein the at least one diagram element includes an edge that connects a source node to a target node and wherein the at least one specialization includes an edge specialization.

23. The computer program product of claim 20, wherein the parent diagram and the specialization diagram are part of a diagram hierarchy.

24. The computer program product of claim 23, further comprising:
instructions for presenting a representation of the diagram hierarchy in a graphical user interface for navigation.

25. The computer program product of claim 24, further comprising:
instructions, responsive to selection of a diagram in the diagram hierarchy, for presenting the selected diagram in the graphical user interface.
